(19) United States
(12) Patent Application Publication
(10) Pub. No.: US 2023/0183487 A1
(43) Pub. Date: Jun. 15, 2023

(54) COCONUT FIBER COMPOSITIONS AND METHODS FOR THE PRODUCTION THEREOF

(71) Applicant: Phoenix World Recycling, LLC, Newport Beach, CA (US)

(72) Inventors: Maksim Sergeevich Kaimakov, Samui (TH); Maksim Alekseevich Gerasimov, Saratov (RU); Sergey Aleksandrovich Evstigneev, Saratov (RU)

(21) Appl. No.: 18/153,724

(22) Filed: Jan. 12, 2023

Related U.S. Application Data
(63) Continuation-in-part of application No. 18/065,090, filed on Dec. 13, 2022.
(60) Provisional application No. 63/288,870, filed on Dec. 13, 2021.

(51) Int. Cl. C08L 97/02; B27N 3/12; B27N 3/04; E04B 1/90

(52) U.S. Cl. CPC C08L 97/02; B27N 3/04; B27N 3/12; E04B 1/90; C08L 2203/12

(57) ABSTRACT

Coconut husk and coconut shells are primarily considered agricultural waste. Therefore, coconut shells are often burned, which is terrible for the environment and contributes significantly to CO2 and methane emissions. Thus, the present invention provides an eco-friendly use for coconut waste by turning coconut fibers into thermo-acoustic insulation. The present invention also describes methods of producing said insulating compositions.

### CROSS-REFERENCES TO RELATED APPLICATIONS

This application is a continuation-in-part and claims benefit of U.S. Pat. Application No. 18/065,090 filed Dec. 13, 2022, which is a non-provisional and claims benefit of U.S. Provisional Application No. 63/288,870 filed Dec. 13, 2021, the specifications of which are incorporated herein in their entirety by reference.

### FIELD OF THE INVENTION

The present invention relates to coconut fiber compositions and methods of producing said coconut fiber compositions.

### BACKGROUND OF THE INVENTION

Coconuts are perennial fruits available in large quantities throughout tropical countries worldwide. Coconuts thrive well on sandy soils and mostly grow on islands and coastal areas in tropical and rainforest climates. Globally, more than ten million hectares are used to produce several million tons of coconut annually.

Almost all of the edible parts of the coconut (e.g., the coconut “meat” and coconut water) are utilized. However, the coconut husk and coconut shells are considered mainly agricultural waste. Therefore, in many countries, coconut shells are subjected to open burning, which is terrible for the environment and contributes significantly to CO₂ and methane emissions.

The present invention provides an eco-friendly use for coconut waste by turning coconut fibers into a thermo-acoustic insulation and/or a board composition.

### BRIEF SUMMARY OF THE INVENTION

It is an objective of the present invention to provide compositions and methods that allow for the production of eco-friendly, cost-effective thermo-acoustic insulation and board compositions, as specified in the independent claims. Embodiments of the invention are given in the dependent claims. Embodiments of the present invention can be freely combined with each other if they are not mutually exclusive.

In some embodiments, the present invention features a coconut fiber composition (e.g., an insulation composition or a board composition) comprising coconut fibers, at least one polymer, and at least one composite additive. In some embodiments, the present invention features a fiber board comprising the coconut fiber compositions described herein. In other embodiments, the present invention features an insulation material comprising the coconut fiber compositions described herein.

In other embodiments, the present invention features a method of preparing a coconut fiber composition (e.g., an insulation composition or a board composition). In some embodiments, the method comprises preparing a raw material (e.g., a fiber). In some embodiments, the method comprises preparing a fiber, such as a coconut fiber. In some embodiments, the method comprises adding and mixing at least one polymer and at least one composite additive with the aforementioned fiber (e.g., raw material; e.g., coconut fiber). In some embodiments, the method comprises forming a fibrous carpet. In some embodiments, the method comprises hot pressing the fibrous carpet. In some embodiments, the method comprises cutting the fibrous carpet.

One of the unique and inventive technical features of the present invention is the special recipe and process of making the insulation composition that reduces or completely eliminates formaldehyde emissions from the material. Without wishing to limit the invention to any theory or mechanism, it is believed that the technical feature of the present invention advantageously provides for thermo-acoustic insulation that is fire-resistant, bio-resistant (including but not limited to mold-resistant and water-resistant) hypo-allergenic, anti-microbial, insect/dust mite resistant. None of the presently known prior references or work has the unique, inventive technical feature of the present invention.

Furthermore, the inventive technical features of the present invention contributed to a surprising result. For example, the material does not cause a negative effect (such as the emission of harmful substances) on humans under normal and aggressive conditions (extreme heating, fire), as it is not synthetic.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1 shows non-limiting examples of the coconut fiber-based compositions described herein.

FIG. 2 shows a non-limiting example of a method to prepare the coconut fiber-based compositions described herein.

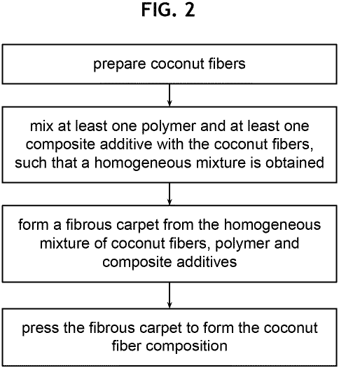

### DETAILED DESCRIPTION OF THE INVENTION

For purposes of summarizing the disclosure, certain aspects, advantages, and novel features of the disclosure are described herein. It is to be understood that not necessarily all such advantages may be achieved in accordance with any particular embodiments of the disclosure. Thus, the disclosure may be embodied or carried out in a manner that achieves or optimizes one advantage or group of advantages as taught herein without necessarily achieving other advantages as may be taught or suggested herein.

Additionally, although embodiments of the disclosure have been described in detail, certain variations and modifications will be apparent to those skilled in the art, including embodiments that do not provide all the features and benefits described herein. It will be understood by those skilled in the art that the present disclosure extends beyond the specifically disclosed embodiments to other alternative or additional embodiments and/or uses and obvious modifications and equivalents thereof. Moreover, while a number of variations have been shown and described in varying detail, other modifications, which are within the scope of the present disclosure, will be readily apparent to those of skill in the art based upon this disclosure. It is also contemplated that various combinations or sub-combinations of the specific features and aspects of the embodiments may be made and still fall within the scope of the present disclosure. Accordingly, it should be understood that various features and aspects of the disclosed embodiments can be combined with or substituted for one another in order to form varying modes of the present disclosure. Thus, it is intended that the scope of the present disclosure herein disclosed should not be limited by the particular disclosed embodiments described herein.

As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.”

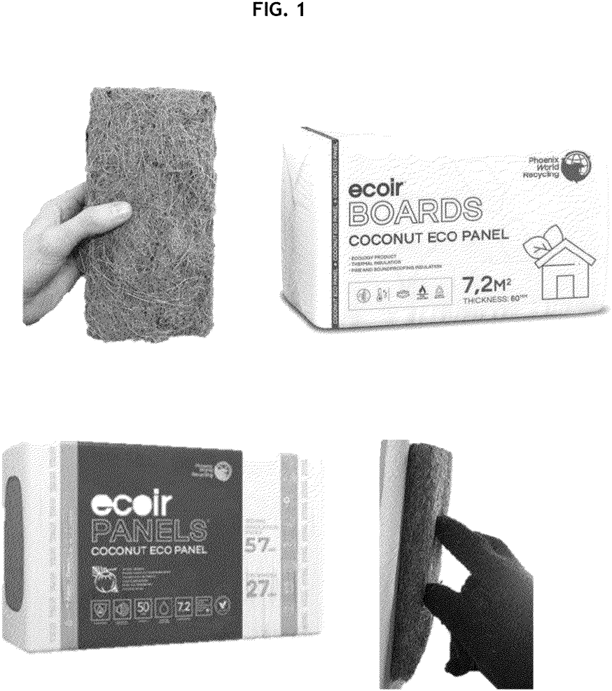

Referring now to FIG. 1, the present invention relates to building materials, namely, sound and thermal insulation from organic materials (e.g., coconut fibers). In some embodiments, the present invention features coconut fiber compositions (e.g., an insulation composition or a board composition) comprising coconut fibers, at least one polymer, and at least one composite additive.

In some embodiments, coconut fibers (e.g., coir) used herein are from the outer shell (e.g., husk; e.g., mesocarp) of the coconut. In some embodiments, the compositions described herein utilize the outer coconut shell (e.g., the mesocarp) comprising the coconut fibers (e.g., coir) and exclude the inner coconut shell (e.g., the seed coat, e.g., endocarp).

In certain embodiments, the compositions described herein comprise about 65% wt wt to 75% wt wt coconut fiber. In some embodiments, the compositions described herein comprise about 55% wt wt to 80% wt wt, or about 55% wt to 75% wt, or about 55% wt to 70% wt, or about 55% wt to 65% wt, or about 55% wt to 60% wt coconut fiber. In some embodiments, the compositions described herein comprise about 60% wt to 80% wt, or about 60% wt to 75% wt, or about 60% wt to 70% wt, or about 60% wt to 65% wt coconut fiber. In some embodiments, the compositions described herein comprise about 65% wt to 80% wt, or about 65% wt to 75% wt, or about 65% wt to 70% wt, or about 70% wt to 80% wt, or about 70% wt to 75% wt, or about 75% wt to 80% wt coconut fiber. In some embodiments, the compositions described herein comprise about 55% wt, about 60% wt, about 65% wt, about 70% wt, about 75% wt, or about 80% wt coconut fiber. In some embodiments, the compositions described herein comprise less than 80% wt coconut fiber.

Without wishing to limit the present invention to any theory or mechanism, it is believed that coconut fiber compositions comprising more than 80% wt coconut fiber may be weaker than those comprising 80% wt or less coconut fiber. Additionally, coconut fiber compositions comprising more than 80% wt coconut fiber may have less thermo-acoustic insulation properties than those comprising 80% wt or less coconut fiber.

In some embodiments, the compositions described herein comprise about 25% wt to 35% wt polymer. In some embodiments, the compositions described herein comprise about 15% wt to 45% wt, or about 15% wt to 40% wt, or about 15% wt to 35% wt, or about 15% wt to 30% wt, or about 15% wt to 25% wt, or about 15% wt to 20% wt polymer. In some embodiments, the compositions described herein comprise about 20% wt to 45% wt, or about 20% wt to 40% wt, or about 20% wt to 35% wt, or about 20% wt to 30% wt, or about 20% wt to 25% wt polymer. In some embodiments, the compositions described herein comprise about 25% wt to 45% wt, or about 25% wt to 40% wt, or about 25% wt to 35% wt, or about 25% wt to 30% wt polymer. In some embodiments, the compositions described herein comprise about 30% wt to 45% wt, or about 30% wt to 40% wt, or about 30% wt to 35% wt, or about 35% wt to 45% wt, or about 35% wt to 40% wt, or about 40% wt to 45% wt polymer. In some embodiments, the compositions described herein comprise about 15% wt, about 20% wt, about 25% wt, about 30% wt, about 25% wt, about 40% wt, or about 45% wt polymer. In other embodiments, the compositions described herein comprise about 25% wt polymer.

Non-limiting examples of polymers may include but are not limited to resin (e.g., natural and synthetic), polymer resin, formaldehyde resins, polyvinyl acetate, polyvinyl acetate (PVA) glue, epoxy, latex, albumin, glutin, casein, or a combination thereof. Other polymers may be used in accordance with the compositions described herein to bind the coconut fibers together. In some embodiments, the polymers used herein are environmentally friendly.

In some embodiments, resins described herein may be natural or synthetic. Synthetic resins may be selected from any of the nine main categories of synthetic resin, which include but are not limited to alkyd, amino resins, glyph, indene-coumarone, urea-formaldehyde, petroleum polymer, terpene, phenolformaldehyde, epoxy, or a combination thereof. Non-limiting examples of natural resins may include but are not limited to lignin or natural liquid latex.

Additionally, in some embodiments, the polymers may include adhesives. Adhesives may be selected from any of the three main categories of adhesives which may include adhesives of animal origins, adhesives of vegetable origins, or adhesives from synthetic resins. Non-limited examples of adhesives that may be used in compositions described herein include but are not limited to casein, vegetable/protein glues (e.g., glues from soybeans or glues based on blood protein, these may be used alone or in combination with soy protein or phenolic resins), casein glues, pine rosin, synthetic adhesives (e.g., phenolic adhesives, urea adhesives, resorcinol, and phenolresorcinol adhesives, or a combination thereof.

In some embodiments, polymers described herein may include urea-formaldehyde resins and adhesives derivatives thereof. In some embodiments, polymers described herein may include melamine resins and adhesives derivatives thereof. In some embodiments, polymers described herein may include phenol formaldehyde resins and adhesive derivatives thereof. In some embodiments, polymers described herein may include resorcinol and phenol-resorcinol resins.

In some embodiments, the compositions described herein comprise about 2.5% wt to 8% wt composite additives. In some embodiments, the compositions described herein comprise about 0.1% wt to 10% wt, or about 0.1% wt to 9.0% wt, or about 0.1% wt to 8.0% wt, or about 0.1% wt to 7.0% wt, or about 0.1% wt to 6.0% wt, or about 0.1% wt to 5.0% wt or about 0.1% wt to 4.0% wt, or about 0.1% wt to 3.5% wt, or about 0.1% wt to 3.0% wt, or about 0.1% wt to 2.5% wt, or about 0.1% wt to 2.0% wt, or about 0.1% wt to 1.5% wt, or about 0.1% wt to 1.0%, or about 0.1% wt to 0.5% wt, or about 0.5% wt to 10% wt, or about 0.5% wt to 9.0% wt, or about 0.5% wt to 8.0% wt, or about 0.5% wt to 7.0% wt, or about 0.5% wt to 6.0% wt, or about 0.5% wt to 5.0% wt or about 0.5% wt to 4.0% wt, or about 0.5% wt to 3.5% wt, or about 0.5% wt to 3.0% wt, or about 0.5% wt to 2.5% wt, or about 0.5% wt to 2.0% wt, or about 0.5% wt to 1.5% wt, or about 0.5% wt to 1.0% wt composite additives. In some embodiments, the compositions described herein comprise about 1.0% wt to 10% wt, or about 1.0% wt to 9.0% wt, or about 1.0% wt to 8.0% wt, or about 1.0% wt to 7.0% wt, or about 1.0% wt to 6.0% wt, or about 1.0% wt to 5.0% wt or about 1.0% wt to 4.0% wt, or about 1.0% wt to 3.5% wt, or about 1.0% wt to 3.0% wt, or about 1.0% wt to 2.5% wt, or about 1.0% wt to 2.0% wt, or about 1.0% wt to 1.5% wt, or about 1.5% wt to 10% wt, or about 1.5% wt to 9.0% wt, or about 1.5% wt to 8.0% wt, or about 1.5% wt to 7.0% wt, or about 1.5% wt to 6.0% wt, or about 1.5% wt to 5.0% wt or about 1.5% wt to 4.0% wt, or about 1.5% wt to 3.5% wt, or about 1.5% wt to 3.0% wt, or about 1.5% wt to 2.5% wt, or about 1.5% wt to 2.0% wt composite additives. In some embodiments, the compositions described herein comprise about 2.0% wt to 10% wt, or about 2.0% wt to 9.0% wt, or about 2.0% wt to 8.0% wt, or about 2.0% wt to 7.0% wt, or about 2.0% wt to 6.0% wt, or about 2.0% wt to 5.0% wt or about 2.0% wt to 4.0% wt, or about 2.0% wt to 3.5% wt, or about 2.0% wt to 3.0% wt, or about 2.0% wt to 2.5% wt, or about 2.5% wt to 10% wt, or about 2.5% wt to 9.0% wt, or about 2.5% wt to 8.0% wt, or about 2.5% wt to 7.0% wt, or about 2.5% wt to 6.0% wt, or about 2.5% wt to 5.0% wt or about 2.5% wt to 4.0% wt, or about 2.5% wt to 3.5% wt, or about 2.5% wt to 3.0% wt composite additives. In some embodiments, the compositions described herein comprise about 3.0% wt to 10% wt, or about 3.0% wt to 9.0% wt, or about 3.0% wt to 8.0% wt, or about 3.0% wt to 7.0% wt, or about 3.0% wt to 6.0% wt, or about 3.0% wt to 5.0% wt or about 3.0% wt to 4.0% wt, or about 3.0% wt to 3.5% wt, or about 3.5% wt to 10% wt, or about 3.5% wt to 9.0% wt, or about 3.5% wt to 8.0% wt, or about 3.5% wt to 7.0% wt, or about 3.5% wt to 6.0% wt, or about 3.5% wt to 5.0% wt or about 3.5% wt to 4.0% wt composite additives. In some embodiments, the compositions described herein comprise about 4.0% wt to 10% wt, or about 4.0% wt to 9.0% wt, or about 4.0% wt to 8.0% wt, or about 4.0% wt to 7.0% wt, or about 4.0% wt to 6.0% wt, or about 4.0% wt to 5.0% wt, or about 5.0% wt to 10% wt, or about 5.0% wt to 9.0% wt, or about 5.0% wt to 8.0% wt, or about 5.0% wt to 7.0% wt, or about 5.0% wt to 6.0% wt composite additives. In some embodiments, the compositions described herein comprise about 6.0% wt to 10% wt, or about 6.0% wt to 9.0% wt, or about 6.0% wt to 8.0% wt, or about 6.0% wt to 7.0% wt, or about 7.0% wt to 10% wt, or about 7.0% wt to 9.0% wt, or about 7.0% wt to 8.0% wt, or about 8.0% wt to 10% wt, or about 8.0% wt to 9.0% wt, or about 9.0% wt to 10% wt composite additives. In other embodiments, the compositions described herein comprise about 1.0% wt, about 1.5% wt, about 2.0% wt, about 2.5% wt, about 3.0% wt, about 3.5% wt, about 4.0% wt, about 5.0% wt, about 6.0% wt, about 7.0% wt, about 8.0% wt, about 9.0% wt, or about 10% wt composite additives. In further embodiments, the compositions described herein comprise about 2.5% wt composite additives.

As used herein, “composite additives” refer to additives that allow the compositions described herein to be waterproof, fireproof, biostable, hygroscopic, or a combination thereof. Non-limiting examples of additives include but are not limited to water-repellent additives, flame-retardant additives, emulsifier additives, antiseptic additives, precipitant additives, stabilizing additives (e.g., biostabilizing additives), additives neutralizing emissions, bio-persistent additives, heat-resistant additives, or a combination thereof.

Non-limiting examples of composite additives include but are not limited to hardeners, plasticizers, paraffin emulsion, silicone, or a combination thereof.

Non-limiting examples of water-repellent additives include but are not limited to paraffin, ozocerite, atactic polypropylene, tall oil with desiccant, gossypol resin, low molecular weight polyethylene waste, ceresin, ceresin composition, distillate slack, or a combination thereof. Non-limiting examples of flame retardant additives include but are not limited to phosphoric acid, urea, dicyandiamide, nepheline flame retardant with asbestos, ammonium phosphates and sulfates, borax, boric acid, or a combination thereof. Non-limiting examples of biostabilizing additives (e.g., additives for biostability) include but are not limited to ammonium fluorosilicon, salicylic acid anilide, sodium pentachlorophenolate, or a combination thereof. Non-limiting examples of emulsifier additives include but are not limited to oleic, stearic, palmitic acids, oleic acid with ammonia, lignosulfonate, synthetic fatty acid residues, or a combination thereof. A non-limiting example of an antiseptic additive includes but is not limited to sodium pentachrophenolate. Non-limiting examples of precipitant additives include but are not limited to alumina sulfate solution, potassium alum, sulfuric acid, aluminum sulfate, or a combination thereof.

In some embodiments, the insulating compositions described herein can be used at temperatures from 60° C. to -40° C. In some embodiments, the insulating compositions described herein can be used at temperatures from 40° C. to -20° C. In other embodiments, the insulating compositions described herein can be used at temperatures from 40° C. to -10° C. In further embodiments, the insulating compositions described herein can be used at temperatures from 40° C. to 0° C. In some embodiments, the insulating compositions described herein are suitable for temperate continental climates.

In some embodiments, the insulating compositions described herein have a thermal conductivity of about 0.05 W/(m·K). In other embodiments, the insulating compositions described herein have a thermal conductivity of about 0.01 W/(m·K) to 0.15 W/(m·K), or about 0.01 W/(m·K) to 0.1 W/(m·K), or about 0.01 W/(m·K) to 0.08 W/(m·K), or about 0.01 W/(m·K) to 0.06 W/(m·K), or about 0.01 W/(m·K) to 0.05 W/(m·K), or about 0.01 W/(m·K) to 0.035 W/(m·K), or about 0.01 W/(m·K) to 0.02W/(m·K), or about 0.02 W/(m·K) to 0.15 W/(m·K), or about 0.02 W/(m·K) to 0.1 W/(m·K), or about 0.02 W/(m·K) to 0.08 W/(m·K), or about 0.02 W/(m·K) to 0.06 W/(m·K), or about 0.02 W/(m·K) to 0.05 W/(m·K), or about 0.02 W/(m·K) to 0.035 W/(m·K). In some embodiments, the insulating compositions described herein have a thermal conductivity of about 0.035 W/(m·K) to 0.15 W/(m·K), or about 0.035 W/(m·K) to 0.1 W/(m·K), or about 0.035 W/(m·K) to 0.08 W/(m·K), or about 0.035 W/(m·K) to 0.06 W/(m·K), or about 0.035 W/(m·K) to 0.05 W/(m·K), or about 0.05 W/(m·K) to 0.15 W/(m·K), or about 0.05 W/(m·K) to 0.1 W/(m·K), or about 0.05 W/(m·K) to 0.08 W/(m·K), or about 0.05 W/(m·K) to 0.06 W/(m·K), or about 0.06 W/(m·K) to 0.15 W/(m·K), or about 0.06 W/(m·K) to 0.1 W/(m·K), or about 0.06 W/(m·K) to 0.08 W/(m·K), or about 0.08 W/(m·K) to 0.15 W/(m·K), or about 0.08 W/(m·K) to 0.1 W/(m·K), or about 0.1 W/(m·K) to 0.15 W/(m·K). In further embodiments, the insulating compositions described herein have a thermal conductivity of about 0.01 W/(m·K), about 0.02 W/(m·K), about 0.034 W/(m·K), about 0.05 W/(m·K), about 0.06 W/(m·K), about 0.08 W/(m·K), about 0.10 W/(m·K), or about 0.15 W/(m·K).

In some embodiments, the insulating compositions described herein have a thickness of about 2.5 cm, or about 5 cm, or about 10 cm, or about 15 cm, or about 20 cm. In some embodiments, the thickness of the insulating compositions described herein depends on the climate area. For example, warmer climates may require a thinner insulating composition, whereas a colder climate may require a thicker insulating composition.

In some embodiments, the insulating compositions (e.g., the thermo-acoustic insulation) described herein have a density of about 50 kg/m³. In other embodiments, the insulating compositions (e.g., the thermo-acoustic insulation) described herein have a density of about 20 kg/m³ to 100 kg/m³, or about 20 kg/m³ to 90 kg/m³, or about 20 kg/m³ to 80 kg/m³, or about 20 kg/m³ to 70 kg/m³, or about 20 kg/m³ to 60 kg/m³, or about 20 kg/m³ to 50 kg/m³, or about 20 kg/m³ to 40 kg/m³, or about 20 kg/m³ to 30 kg/m³. In some embodiments, the insulating compositions (e.g., the thermo-acoustic insulation) described herein have a density of about 30 kg/m³ to 100 kg/m³, or about 30 kg/m³ to 90 kg/m³, or about 30 kg/m³ to 80 kg/m³, or about 30 kg/m³ to 70 kg/m³, or about 30 kg/m³ to 60 kg/m³, or about 30 kg/m³ to 50 kg/m³, or about 30 kg/m³ to 40 kg/m³. In some embodiments, the insulating compositions (e.g., the thermo-acoustic insulation) described herein have a density of about 40 kg/m³ to 100 kg/m³, or about 40 kg/m³ to 90 kg/m³, or about 40 kg/m³ to 80 kg/m³, or about 40 kg/m³ to 70 kg/m³, or about 40 kg/m³ to 60 kg/m³, or about 40 kg/m³ to 50 kg/m³. In some embodiments, the insulating compositions (e.g., the thermo-acoustic insulation) described herein have a density of about 50 kg/m³ to 100 kg/m³, or about 50 kg/m³ to 90 kg/m³, or about 50 kg/m³ to 80 kg/m³, or about 50 kg/m³ to 70 kg/m³, or about 50 kg/m³ to 60 kg/m³, or about 60 kg/m³ to 100 kg/m³, or about 60 kg/m³ to 90 kg/m³, or about 60 kg/m³ to 80 kg/m³, or about 60 kg/m³ to 70 kg/m³, or about 70 kg/m³ to 100 kg/m³, or about 70 kg/m³ to 90 kg/m³, or about 70 kg/m³ to 80 kg/m³, or about 80 kg/m³ to 100 kg/m³, or about 80 kg/m³ to 90 kg/m³, or about 90 kg/m³ to 100 kg/m³. In further embodiments, the insulating compositions described herein have a density of about 20 kg/m³, about 30 kg/m³, about 40 kg/m³, about 50 kg/m³, about 60 kg/m³, about 70 kg/m³, about 80 kg/m³, about 90 kg/m³, or about 100 kg/m³.

In some embodiments, the board compositions (e.g., coconut fiber boards, e.g., cocowood) described herein have a density of about 230 kg/m³ to 250 kg/m³. In other embodiments, the board compositions (e.g., coconut fiber boards, e.g., cocowood) described herein have a density of about 200 kg/m³ to 300 kg/m³, or about 200 kg/m³ to 290 kg/m³, or about 200 kg/m³ to 280 kg/m³, or about 200 kg/m³ to 270 kg/m³, or about 200 kg/m³ to 260 kg/m³, or about 200 kg/m³ to 250 kg/m³, or about 200 kg/m³ to 240 kg/m³, or about 200 kg/m³ to 230 kg/m³, or about 200 kg/m³ to 220 kg/m³, or about 200 kg/m³ to 210 kg/m³, or about 210 kg/m³ to 300 kg/m³, or about 210 kg/m³ to 290 kg/m³, or about 210 kg/m³ to 280 kg/m³, or about 210 kg/m³ to 270 kg/m³, or about 210 kg/m³ to 260 kg/m³, or about 210 kg/m³ to 250 kg/m³, or about 210 kg/m³ to 240 kg/m³, or about 210 kg/m³ to 230 kg/m³, or about 210 kg/m³ to 220 kg/m³. In some embodiments, the board compositions (e.g., coconut fiber boards, e.g., cocowood) described herein have a density of about 220 kg/m³ to 300 kg/m³, or about 220 kg/m³ to 290 kg/m³, or about 220 kg/m³ to 280 kg/m³, or about 220 kg/m³ to 270 kg/m³, or about 220 kg/m³ to 260 kg/m³, or about 220 kg/m³ to 250 kg/m³, or about 220 kg/m³ to 240 kg/m³, or about 220 kg/m³ to 230 kg/m³, or about 230 kg/m³ to 300 kg/m³, or about 230 kg/m³ to 290 kg/m³, or about 230 kg/m³ to 280 kg/m³, or about 230 kg/m³ to 270 kg/m³, or about 230 kg/m³ to 260 kg/m³, or about 230 kg/m³ to 250 kg/m³, or about 230 kg/m³ to 240 kg/m³. In some embodiments, the board compositions (e.g., coconut fiber boards, e.g., cocowood) described herein have a density of about 240 kg/m³ to 300 kg/m³, or about 240 kg/m³ to 290 kg/m³, or about 240 kg/m³ to 280 kg/m³, or about 240 kg/m³ to 270 kg/m³, or about 240 kg/m³ to 260 kg/m³, or about 240 kg/m³ to 250 kg/m³, or about 250 kg/m³ to 300 kg/m³, or about 250 kg/m³ to 290 kg/m³, or about 250 kg/m³ to 280 kg/m³, or about 250 kg/m³ to 270 kg/m³, or about 250 kg/m³ to 260 kg/m³. In other embodiments, the board compositions (e.g., coconut fiber boards, e.g., cocowood) described herein have a density of about 260 kg/m³ to 300 kg/m³, or about 260 kg/m³ to 290 kg/m³, or about 260 kg/m³ to 280 kg/m³, or about 260 kg/m³ to 270 kg/m³, or about 270 kg/m³ to 300 kg/m³, or about 270 kg/m³ to 290 kg/m³, or about 270 kg/m³ to 280 kg/m³, or about 280 kg/m³ to 300 kg/m³, or about 280 kg/m³ to 290 kg/m³. In further embodiments, the board compositions (e.g., coconut fiber boards, e.g., cocowood) described herein have a density of about 200 kg/m³, about 210 kg/m³, about 220 kg/m³, about 230 kg/m³, about 240 kg/m³, about 250 kg/m³, about 260 kg/m³, about 270 kg/m³, about 280 kg/m³, about 290 kg/m³, or about 300 kg/m³.

In some embodiments, the compositions described herein are fire-resistant, mold-resistant, and water resistant. In some embodiments, the compositions described herein are hypo-allergenic. In some embodiments, the compositions described herein are anti-microbial, insect, and dust mite resistant.

According to other embodiments, the present invention features a method of preparing an insulating composition. In some embodiments, the method comprises preparing a raw material. In some embodiments, the method comprises preparing a fiber, such as a coconut fiber. In some embodiments, the method comprises mixing at least one polymer and at least one composite additive with the aforementioned fiber. In some embodiments, the method comprises forming a fibrous carpet. In some embodiments, the method comprises hot pressing the fibrous carpet. In some embodiments, the method comprises cutting the fibrous carpet.

As used herein, “raw material” refers to the basic material (i.e., coconut husks) from which the composition is made. As used herein, a “coconut husk” may refer to the outer covering of a coconut comprising fibers (e.g., coir).

In some embodiments, preparing the raw material comprises grinding a coconut husk. In other embodiments, preparing the raw material comprises sifting the coconut fiber. In further embodiments, preparing the raw material comprises drying the coconut fiber.

In some embodiments, preparing the fiber (e.g., the coconut fiber) comprises chopping the fiber (e.g., the coconut fiber). In other embodiments, preparing the fiber (e.g., the coconut fiber) comprises washing the fiber (e.g., the coconut fiber). In further embodiments, preparing the fiber (e.g., the coconut fiber) comprises steaming the fiber.

In some embodiments, the methods described herein further comprise packaging and warehousing of the cut fibrous carpet.

In some embodiments, the present invention features a method of preparing coconut fiber composition (e.g., an insulation composition or a board composition). The method may comprise preparing raw materials. In some embodiments, the raw material is coconut waste (e.g., coconut husk). In some embodiments, preparing the raw material comprises creating fiber from the raw material and sieving the fiber. In some embodiments, the method comprises supplying the fiber to an air mixing chamber. In some embodiments, the method comprises preparing a binder (e.g., chamber). In some embodiments, the method comprises feeding the fiber into an emulsion spraying chamber (e.g., a chamber in which the coconut fibers are mixed and sprayed with polymer(s) and/or composite additive(s)). In some embodiments, the method comprises settling the fiber and feeding the fiber for pre-pressing. In some embodiments, the method comprises pressing the fiber. In some embodiments, the method comprises forming a tunnel in the pressed fiber and drying. In some embodiments, the method comprises cutting the material. In some embodiments, the method comprises packaging the material.

In some embodiments, an air mixing chamber may refer to a special chamber (e.g., room) with airflow and nozzles on the wall (e.g., sides). The clean and dry coconut fibers are moved and mixed in the air mixing chamber with air, and then the composite additives are sprayed onto the coconut fibers via the nozzles.

In some embodiments, a binder (e.g., chamber) may comprise an air-mixing binder (e.g., chamber). In some embodiments, the air mixing binder may comprise a chamber where the coconut fibers are mixed with air and sprayed with polymers and composite additives. In some embodiments, the air mixing binder (e.g., chamber) may further comprise a camera(s) to view the coconut fibers as they are being mixed with air and sprayed with polymers and composite additives.

The present invention may feature a method of preparing a coconut fiber composition. The method may comprise preparing coconut fibers, adding at least one polymer and at least one composite additive to the prepared coconut fibers, and mixing the at least one polymer and the at least one composite additive with the prepared coconut fibers such that a homogeneous mixture is obtained and the polymer and the composite additive are evenly distributed throughout the coconut fibers. The method may further comprise forming a fibrous carpet from the coconut fibers comprising the polymer and composite additives. In some embodiments, the method further comprises pressing (e.g., hot pressing) the fibrous carpet material. In some embodiments, the method may further comprise cutting the fibrous carpet to a desired size.

In some embodiments, the method comprises preparing an outer shell (e.g., husk) of a coconut. In some embodiments, preparing the outer shell of the coconut comprises grinding the outer coconut shell to obtain the coconut fibers. In some embodiments, preparing the coconut fibers comprises sieving the coconut fibers to remove dust from the coconut fibers. In some embodiments, preparing the coconut fibers comprises drying the coconut fibers. In some embodiments, preparing the coconut fibers comprises washing and drying the coconut fibers.

In some embodiments, the method comprises adding the coconut fibers to an air-mixing chamber. In some embodiments, the air-mixing chamber allows the coconut fibers to be suspended in the air. In some embodiments, the air-mixing chamber allows the coconut fibers to be suspended in the air while the polymer(s) and the composite additive(s) are added to the coconut fibers.

Without wishing to limit the present invention to any theory or mechanism, it is believed that the suspension of coconut fibers in the air-mixing chambers allows the polymer and the composite additive to evenly distribute throughout the coconut fibers. Additionally, after the polymer and composite additives are added to the coconut fibers and while the coconut fibers are still suspended in air, the coconut fibers can collide with each other, interlock, and create conditions for flocculation (e.g., creating larger coconut fiber aggregates). Additionally, as the coconut fibers fall to the ground of the air-mixing chamber (e.g., from gravity and/or from the coconut fibers), a random pattern of coconut fibers will begin to form which also for a greater degree of their adhesion and interlacing (e.g., forming a fibrous carpet).

In some embodiments, the polymer and the composite additive are added to the prepared coconut fibers simultaneously. In other embodiments, the polymer and the composite additive are added to the prepared coconut fibers sequentially, e.g., the polymer is added first, and then the composite additive is added (or vice versa).

In some embodiments, the methods described herein may be performed in a single chamber (e.g., an air-mixing chamber). In other embodiments, the method described herein may be performed in multiple chambers. In some embodiments, the chambers may comprise one or more cameras that may be used to view the coconut fibers throughout the methods described herein, e.g., to view the coconut fibers as the polymer and/or composite additives are added and mixed with the prepared coconut fibers.

Without wishing to limit the present invention to any theory or mechanism, it is believed that the thickness of the insulating composition described herein can change the insulating properties of the compositions (i.e., a thicker insulating composition will have a reduced thermal conductivity).

A non-limiting example of a composition described herein comprises 75% wt coconut fiber, 20% wt latex (e.g., a polymer), and 5% composite additives.

A non-limiting example of a composition described herein comprises 65% wt coconut fiber, 20% wt polyvinyl acetate (PVA) glue (e.g., a polymer), 14.9% wt resin (e.g., Vinnapas®; e.g., a polymer) and 0.1% wt silicone (e.g., composite additives).

### EXAMPLE

The following is a non-limiting example of the present invention. It is to be understood that said example is not intended to limit the present invention in any way. Equivalents or substitutes are within the scope of the present invention.

The goal of the present invention is to solve the problem of coconut fiber waste (e.g., coconut husks). The composition and methods described herein allow coconut fiber waste (e.g., coconut husks) to be used as a construction material with proper strength and reliability characteristics.

The present invention features lightweight compositions (e.g., coconut fiber insulation or coconut fiber boards) that are easy to install. Additionally, the use of coconut fibers in the creation of the aforementioned compositions helps to reduce deforestation. Lastly, due to the physical and chemical properties of the compositions herein, they are very comparable with other polymer heat-insulating building materials currently used.

The main objective of the present invention is to create a heat-insulating building material with coconut fiber, without losing physical and mechanical properties, is to maintain the environmental performance of fiber boards and replace synthetic counterparts.

First, conditions for the formation of the material of the required size and technical characteristics were selected. A large number of tests were carried out for the selection of the pressure during molding, the hardening time of chemical components (e.g., polymers and additives), and their quantity. The final stage was conducted to test control samples to obtain the technical characteristics of the obtained prototypes. The density of the material, the coefficient of sound insulation, and thermal conductivity were determined.

| | | |
|---|---|---|
| Density | Sound insulation coefficient | Thermal conductivity |
| 230 to 250 kg/m³ | 23 to 26 dB | 0.05 W/Mk |

Groups of samples with polyvinyl acetate (Curvalin D 4037) and Formaldehyde Resin were selected: 6 samples 200×100×10; 6 samples 200×100×10; 6 samples 200×100×100; 6 samples 100×100×100.

The average values between the tested groups did not exceed 5%.

Described herein are methods for producing fibrous heat and sound insulating boards and/or rigid boards (i.e., cocowood) based on raw source origin, which are in the method of forming a coconut carpet and its further processing.

The technological process of production of coconut fiber boards includes: receiving, storing, and preparing fibrous raw materials (e.g., coconut fiber); obtaining coconut fibers; receiving and storing chemicals (e.g., polymers and composite additives), preparing chemical compositions (e.g., polymers and composite additives), air mixing, carpet forming, drying, heat treatment and moistening of boards, format cutting, and storage.

Preparation of coconut fiber: Upon receipt, the outer shell (e.g., the husk) of a coconut undergoes stages of grinding, sieving, washing from dust, and drying. Further, dry, clean, without inclusions - coconut fiber enters the disintegrator (or similar grinding equipment). After the disintegrator, the ground fiber enters the stock bunker. Alternatively, upon receipt, the outer shell (e.g., the husk) of the coconut simply undergoes stages of grinding and sieving (e.g., sifting, which removes the dust from the coconut fibers), then the coconut fibers enter the disintegrator.

Mixing and processing of fibers: The dried coconut fiber is fed by a belt feeder into a pre-loading chamber and then into the mixing chamber by a pump with a chemical composite (e.g., a primary polymer and composite additives) that improves the quality characteristics of the material.

The chemical composite (e.g., polymers and composite additives) is sprayed entirely at once or in stages through nozzles in the chamber’s walls.

Each coconut fiber, being suspended in suspension, moves. It occurs, firstly, under the action of gravity (e.g., the particle descends), and secondly, depending on its shape, it lends itself to rotation. Due to the developed outer surface of the fibers obtained during grinding, conditions are created for a greater degree of their adhesion and interlacing. Forming complex movements, fiber particles and fibers collide with each other, interlock, and create conditions for flocculation. Further, the flakes fall onto the grid bottom of the chamber, and when the required volume is reached, the mass is mechanically compressed, molded into a soft carpet, to improve the cohesion of the fibers and finishing. relative humidity of the canvas up to 68-72%.

In this state, the sheet becomes transportable, and in addition, the maximum removal of liquid, reduces energy consumption and time for subsequent drying of the plates in the tunnel dryer.

Premolding: After forming a fibrous carpet, it must first be pre-pressed in order to make the carpet sufficiently dense and strong before it is fed into the hot press. As a result of cold pressing, the thickness of the carpet decreases two to three times, and the density increases from 60-65 to 200-300 kg/m3.

For maximum line performance, a continuous belt roller press was chosen. It consists of four independently adjustable heated plate sections. The input drum is also heated. The carpet fed on a steel strip is first “compacted” in a wedge gate at the press inlet and then sequentially passes through the zones of high pressure (4.9-3.9 MPa), calibration (2.5 MPa) and degassing (1.5 MPa). The inlet temperature is 170-240° C.; at the outlet, it decreases by about 40° C. Each pair of rolls (upper and lower) is located on a frame with autonomous control, which allows, among other things, to compensate for the thermal expansion of the metal.

Working 24 hours, the continuous presses provide not only high productivity with consistent product quality, but also exceptional process flexibility. Upon entering the press, the chip or fibrous carpet is immediately compressed and then passes through a zone of reduced pressure. As a result, the outer layers of the carpet quickly warm up and cure, becoming denser. Due to the smooth profile of the inlet section of the heating plates, it is possible to reduce the compression rate as the thickness of the carpet increases, as well as to avoid blowing particles from its surface. The press belt moves at a speed of 1.5 m / s; that is, its productivity is 90 linear meters of wood board per minute.

Special studies have shown that the principle of pressing wood-based panels through is also compatible with steam blowing. To do this, it is necessary to provide in the first zone of the press the supply of steam into a chipped or fibrous carpet, and in the second zone - the removal of the excess vapor-gas mixture from the carpet.

The choice of this press is also because the thickness of the initial fibrous carpet is many times greater than the nominal thickness of the finished product.

After pre-pressing and heat pressing, the soft carpet is moved to the drying unit on a conveyor belt.

Drying: In this technology, a two-stage drying plant is chosen, on which from 8 to 12 rows of roller conveyors are installed and continuous operation with one row of rollers. The direction of air circulation in the tunnels in the first zone is carried out towards the movement of the soft carpet, in the second - in the direction of movement of the soft carpet, which allows:

Provide highly efficient preheating in the first zone, a softer start of drying, during which the primary crystallization of the binder occurs.

To equalize the final humidity in the second zone, as a result of which it is possible to dry panels of different sizes; (materials with different initial humidity are dried with the same high quality); a slight variation in humidity and a higher quality of drying is achieved.

Drying time, depending on the thickness of the product, can range from 30-60 minutes. The drying temperature is 50° C. The moisture content of the dried boards should not exceed 3%, which ensures the high quality of the boards in all respects and eliminates the possibility of spontaneous combustion of the boards when stored in stacks in a warehouse.

The panels go to the finishing trim from drying on a conveyor belt, which allows for sizing and cutting of the boards.

Fiberboards based on coconut are cut to final dimensions on sizing and trimming machines that perform the longitudinal and transverse cutting. The cutting tool - round saws. For cutting out defective areas and more convenient cutting of slabs into workpieces of carpentry and other special products, a preliminary cross-cutting saw is installed in front of the format-cutting machines.

After format cutting, the plates, depending on the type, are sent for the following technological improvements, such as the application of protective films, special compositions for using the material in aggressive environments, etc. After all technological operations are completed, the products are sent to the finished product warehouse.

### Cocowood

The technological process of cocowood production includes: receiving, storing, and preparing fibrous raw materials (e.g., coconut fiber); obtaining coconut fibers; receiving and storing chemicals (e.g., polymer and composite additives); preparing chemical compositions (e.g., polymer and composite additives), air mixing, carpet forming, cold pre-pressing, hot pressing, sizing cutting and warehousing.

Preparation of coconut fiber: When the outer shell (e.g., the husk) of a coconut is received, it goes through the stages of grinding, sieving, washing from dust and drying. Further, dry, clean, without inclusions - coconut fiber enters the defibrator (or similar grinding equipment). After the defibrator, the ground fiber enters the stock bunker. Alternatively, upon receipt, the outer shell (e.g., the husk) of the coconut simply undergoes stages of grinding and sieving (e.g., sifting, which removes the dust from the coconut fibers), then the coconut fibers enter the disintegrator.

Mixing and processing of fibers: From the hopper, dry fiber (e.g., coconut fiber) is fed by a belt feeder into the pre-loading chamber and then by a pump into the mixing chamber with a chemical composite, which includes the main polymer and chemical additives that improve the quality characteristics of the material.

Through the nozzles in the walls of the chamber, the entire chemical composite (e.g., polymers and composite additives) is sprayed or a phased spraying of additives occurs.

Each particle of fibrous mass (e.g., each coconut fiber), being suspended in suspension, makes a movement. It occurs, firstly, under the action of gravity (the particle descends), and secondly, depending on its shape, it lends itself to rotation. Due to the developed outer surface of the fibers obtained during grinding, conditions are created for a greater degree of their adhesion and interlacing. Forming complex movements, fiber particles and fibers collide with each other, interlock, and create conditions for flocculation. Further, the flakes fall on the grid-bottom of the chamber, and when the required volume is reached, the mass is mechanically compressed to improve the cohesion of the fibers and finishing. relative humidity of the canvas up to 68-72%.

In this state, the sheet becomes transportable, and in addition, the maximum removal of liquid, reduces energy consumption and time for subsequent drying of the plates in the tunnel dryer.

Further along the conveyor belt, the soft carpet goes to pre-pressing, hot pressing, and cutting.

Pre-pressure: A soft carpet on a tape is fed into molding frames, which are rolled into a cold press. At this stage, the future plates are pre-pressed in order to make the carpet sufficiently dense and durable before it is fed into the hot press. After the molds are compressed, the sheets are sent to the trolley and transferred to the hot pressing molds.

Benefits of pre-pressing: reduced damage to the outer layers; increased speed of transporting sheets; facilitates the loading of mats into the press; the height of the package and the distance between the plates are reduced.

Hot pressing: The cocowood hot pressing cycle consists of the following periods: loading sheets into the press, lifting and closing the press plates, creating working pressure, holding under pressure and high temperature up to 170 C, where the material gains maximum strength, reducing pressure, unloading finished sheets.

Auxiliary time includes the time required for loading and unloading sheets, for closing and opening the press plates. The holding time under pressure (tpr) depends on the brand of glue, the number of fibers and the temperature of the press plates. The depressurization time consists of two periods. In the first period, the pressure decreases from the maximum level to a safe level equal to the level of steam pressure in the press plates. Usually, this period is 0.25 min. The second period takes 1-3 minutes, since the rapid release of pressure can cause intense vaporization, which will lead to deformations.

The parameters of the cocowood sheet pressing mode include: humidity of the list, usually, it ranges from 12 ± 3%; the number of sheets in the press gap. It is determined by the maximum thickness of the package and depends on the thickness of the cocowood.

The press plate temperature depends on the brand of glue used and the thickness of the sheet. The thicker the sheet, the lower the bonding temperature should be. For phenolic adhesives, a temperature of 10-20° C. is required, higher than for carbamide adhesives.

Operating pressure. It depends on the brand of products and the design of the press elements that transmit pressure.

Sizing cutting of the matts: Cocowood lists after the pressing process are moved to the cutting zone and are cut to final dimensions on sizing and trimming machines that perform longitudinal and transverse cutting. The cutting tool - round saws. For cutting out defective areas and more convenient cutting of the lists into workpieces of carpentry and other special products, a preliminary cross-cutting saw is installed in front of the format-cutting machines.

After format cutting, the lists, depending on the type, are sent for the following technological improvements, such as the application of protective films, special compositions for using the material in aggressive environments, etc. After all technological operations are completed, the products are sent to the finished product warehouse.

As used herein, the term “about” refers to plus or minus 10% of the referenced number.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

What is claimed is:

1. A coconut fiber composition comprising:
a) coconut fibers,
b) at least one polymer, and
c) at least one composite additive.

2. The composition of claim 1, wherein the composition comprises about 65% wt-75% wt coconut fiber.

3. The composition of claim 1, wherein the composition comprises less than 80% coconut fiber.

4. The composition of claim 1, wherein the composition comprises about 20% wt-35% wt polymer.

5. The composition of claim 4, wherein the polymer is selected from a group consisting of latex, natural resin, resin, and polymer additives.

6. The composition of claim 1, wherein the composition comprises about 2.5% wt-5% wt composite additives.

7. The composition of claim 1, wherein the composition is a thermo-acoustic insulation composition.

8. The composition of claim 7, wherein the composition has a density of about 50 to 70 kg/m³.

9. The composition of claim 1, wherein the composition is a board composition.

10. The composition of claim 9, wherein the composition has a density of about 230 to 250 kg/m³.

11. The composition of claim 1, wherein the composition is fire-resistant.

12. The composition of claim 1, wherein the composition is mold-resistant and water-resistant.

13. The composition of claim 1, wherein the composition is hypo-allergenic.

14. The composition of claim 1, wherein the composition is anti-microbial, insect, and dust mite resistant.

15. A fiber board comprising the coconut fiber composition according to claim 1.

16. An insulation material comprising the coconut fiber composition according to claim 1.

17. A method of preparing a coconut fiber composition, the method comprising:
a) preparing coconut fibers;
b) adding and mixing at least one polymer and at least one composite additive with the prepared coconut fibers, wherein the polymer, the composite additive, and the fiber are mixed together such that a homogeneous mixture is obtained and the polymer and the composite additive are evenly distributed throughout the coconut fibers; and
c) forming a fibrous carpet from the coconut fibers comprising the polymer and composite additives.

18. The method of claim 17, wherein the at least one polymer and at least one composite additive are added to the prepared coconut fibers simultaneously.

19. The method of claim 17 further comprising cutting the fibrous carpet to a desired size.

20. The method of claim 19 further comprising pressing the fibrous carpet, wherein pressing the fibrous carpet comprises hot pressing.
